(19) United States
(12) Patent Application Publication
(10) Pub. No.: US 2009/0109534 A1
(43) Pub. Date: Apr. 30, 2009

(54) Multi-Segmented Aiming Diffractive Optical Elements

(76) Inventors: Vladimir Gurevich, Stony Brook, NY (US); David Shi, Stony Brook, NY (US); Chinh Tan, Setauket, NY (US); Heng Zhang, Selden, NY (US)

Correspondence Address: MOTOROLA, INC., 1303 EAST ALGONQUIN ROAD, IL01/3RD, SCHAUMBURG, IL, 60196, US

(21) Appl. No.: 11/931,827

(22) Filed: Oct. 31, 2007

(51) Int. Cl. G02B 27/42

(52) U.S. Cl. 359/558

(57) ABSTRACT

A system having a light source generating a light beam, a collimating lens collimating the light beam into a collimated light beam and a pattern generating element comprising a diffractive optical element portion and a refractive optical element portion, the pattern generating element creating a target pattern from the collimated light beam incident on the pattern generating element.

### FIELD OF INVENTION

The present invention relates generally to devices and systems for improving the efficiency and accuracy of aiming patterns for imagers.

### BACKGROUND

Imagers are commonly used data capture mechanisms for computing devices. To properly use an imager, a user must accurately aim the imager at its target. To assist the user in doing so, imagers typically include an element for generating an aiming pattern showing precisely where the imager is pointed.

Such aiming patterns may be generated using light generated by a laser diode, coupled with a diffractive optical element (“DOE”) to generate an aiming pattern. Ideally, an aiming pattern should accurately represent the imaging field of view and be visible both indoors and outdoors.

### SUMMARY OF THE INVENTION

A device having a diffractive optical element portion diffracting an incident light beam to create a first portion of a target pattern and a refractive optical element portion refracting the incident light beam to create a second portion of the target pattern.

A system having a light source generating a light beam, a collimating lens collimating the light beam into a collimated light beam and a pattern generating element comprising a diffractive optical element portion and a refractive optical element portion, the pattern generating element creating a target pattern from the collimated light beam incident on the pattern generating element.

### BRIEF DESCRIPTION OF THE DRAWINGS

FIG. 1 shows an exemplary embodiment of a pattern generating system for an imager according to the present invention.

FIG. 2 shows an exemplary aiming pattern consisting of a broken cross and central aiming dot used by an imager according to the present invention.

FIG. 3 shows a first exemplary embodiment of a pattern generating element according to the present invention.

FIG. 4 shows a second exemplary embodiment of a pattern generating element according to the present invention.

FIG. 5 shows a third exemplary embodiment of a pattern generating element according to the present invention.

FIG. 6 shows a fourth exemplary embodiment of a pattern generating element according to the present invention.

FIG. 7 shows a fifth exemplary embodiment of a pattern generating element according to the present invention.

FIG. 8 shows a sixth exemplary embodiment of a pattern generating element according to the present invention.

FIG. 9 shows a seventh exemplary embodiment of a pattern generating element according to the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe devices and systems for generating aiming patterns for imaging devices. In the exemplary embodiments, a light source (e.g., a laser diode) emits a beam which shines through a collimating lens and subsequently through a DOE to achieve a desired aiming pattern. Various DOE configurations are disclosed in order to achieve a variety of aiming patterns.

Existing systems for generating aiming patterns typically use a collimating lens with a small input numerical aperture to cut the size of the central circular zone from the radiation of the laser diode. The use of this type of collimating lens results in significant power losses in the aperture of the collimating lens, and thus decreases the brightness of the aiming pattern and limits the total length of the aiming lines. Subsequently, the collimated light passes through a diffractive optical element to generate an aiming pattern. In order to achieve both indoor and outdoor visibility, it is desirable to have an aiming pattern having several lines and dots; when the pattern is generated using DOE, the lines themselves also consist of series of dots. Depending on the complexity of the aiming pattern, the DOE may generate a number of secondary, undesirable aiming dots that make the use of the aiming pattern less intuitive.

In order to maintain the aiming pattern without requiring protective eyewear in conformance with laser safety standards, it is necessary to provide highly accurate laser power distribution among the different parts of the aiming pattern. For some aiming patterns, such as those having one bright central aiming dot for outdoor visibility and a number of aiming lines, it is difficult to maintain an accurate ratio of power distribution between the central dot and the other lines.

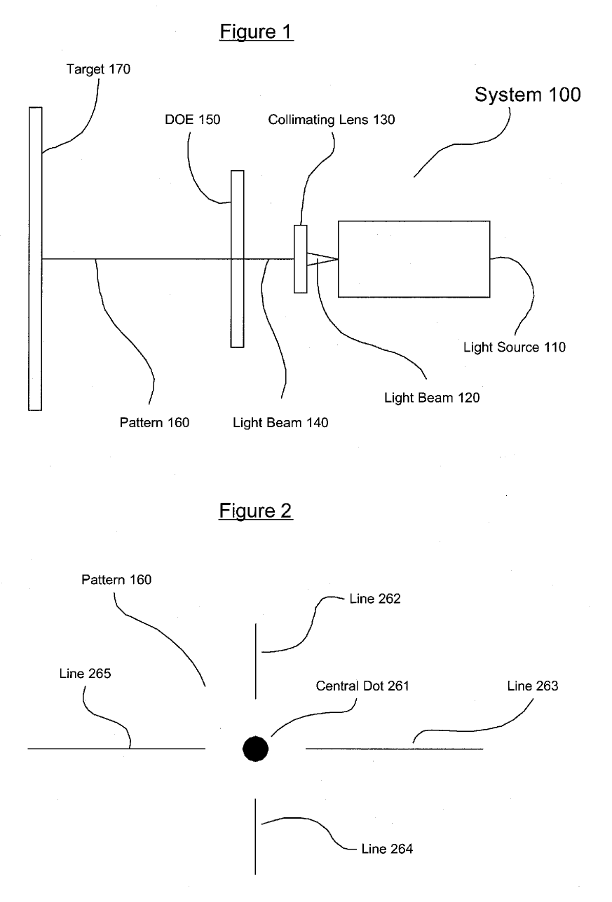

The exemplary embodiments of the present invention use a high numerical aperture laser collimating lens in combination with a multi-segmented DOE to provide a number of improvements over prior existing systems. FIG. 1 shows an exemplary embodiment of a system 100 for generating an aiming pattern for an imager. The system includes a light source 110, which may typically be a laser diode, but in other embodiments of the present invention may be any other type of light source capable of generating light suitable for use to generate an aiming pattern. The light source 110 generates an unfocused beam of light 120, which is collected and focused by a collimating lens 130. As described above, the collimating lens 130 may be a high numerical aperture lens.

The use of this type of lens provides a number of advantages over prior systems that use small numerical aperture collimating lenses. A high numerical aperture collimating lens may increase the brightness of the aiming pattern generated by the system 100. Further, it may help to reduce secondary, unwanted pattern dots. Additionally, the high numerical aperture collimating lens may help to sharpen the aiming lines and dots that are created. Finally, it may provide better control of the laser power distribution among different features of the aiming pattern.

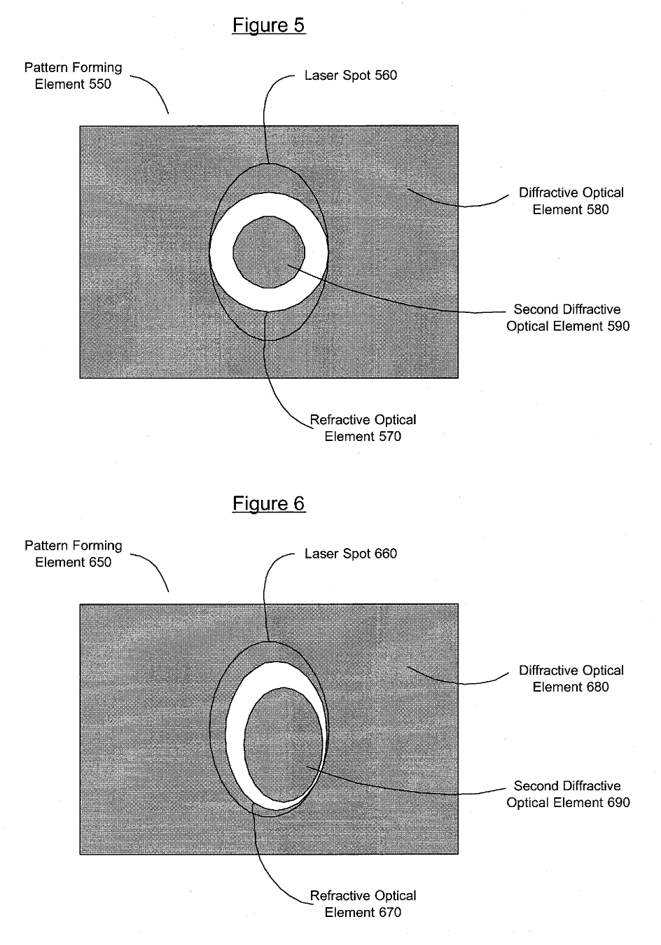

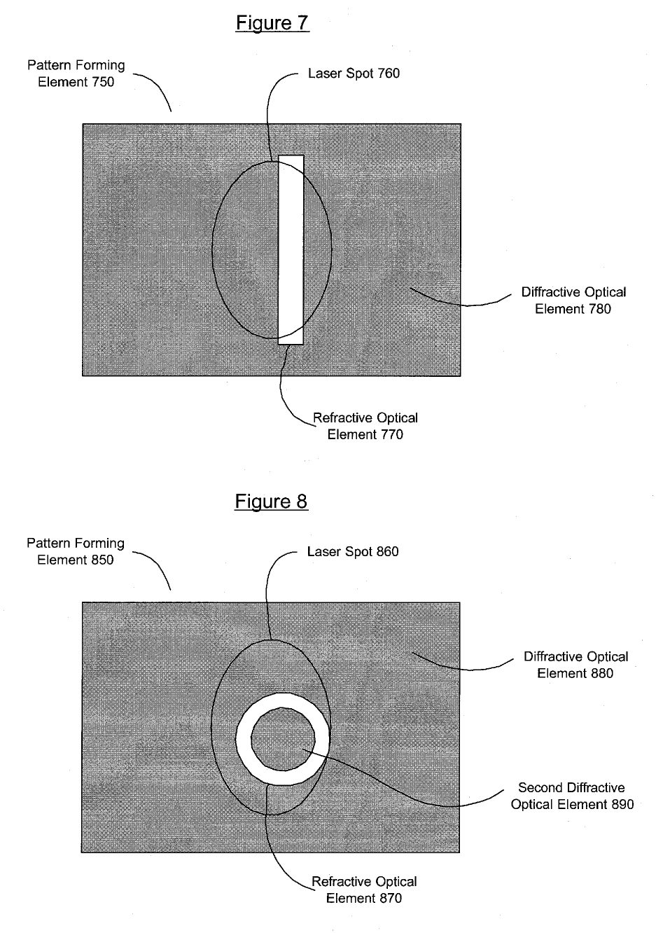

The collimating lens 130 may emit a focused, collimated light beam 140. The light beam 140 may then become incident upon a multi-segmented pattern forming element 150, which will be described in further detail below. The pattern forming element may be, for example, the pattern forming element 350 of FIG. 3, the pattern forming element 450 of FIG. 4, the pattern forming element 550 of FIG. 5, the pattern forming element 650 of FIG. 6, the pattern forming element 750 of FIG. 7, or another pattern element featuring a similar combination of features. From the pattern forming element 150, an aiming pattern 160, which will also be discussed in further detail below, is projected on a target 170. The target 170 may be a pattern, image, or other input to be acquired by an imager that uses the pattern generating system 100, or may be any other object that the pattern 160 is shining on to show a user of the imager where it is currently aimed.

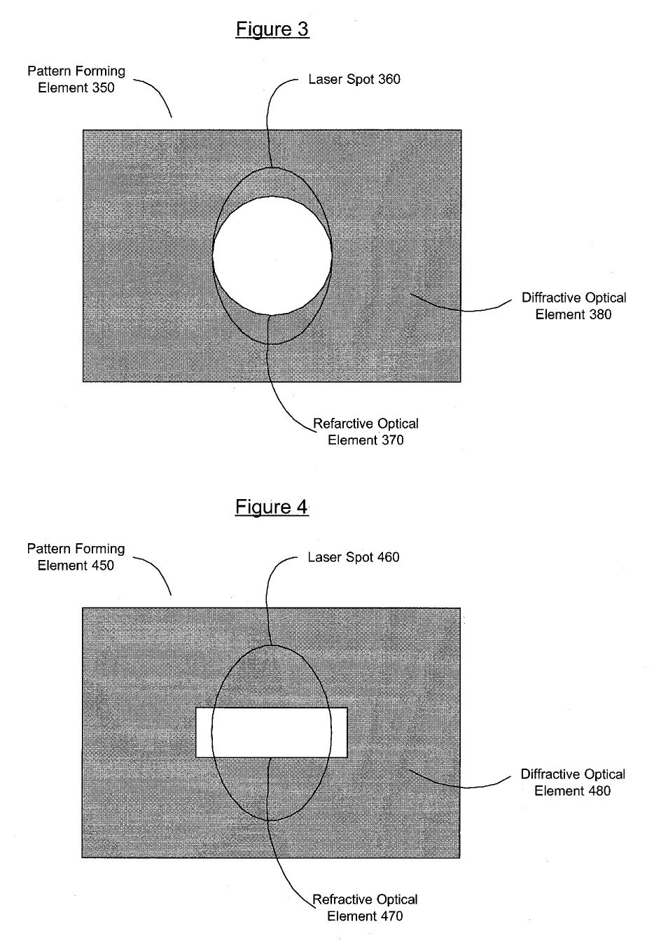

FIG. 2 shows an exemplary pattern 160 that may be projected onto the target 170. The exemplary pattern 160 comprises a central dot 261 and aiming lines 262, 263, 264, 265. In this exemplary embodiment, the aiming lines 262, 263, 264, 265 form a crosshair oriented so as to be centered around central dot 261. Typically, the outer ends of the aiming lines 262, 263, 264, 265 may show a user the outer borders of the imaging area, while the central dot 261 may be bright enough to be visible outdoors.

FIG. 3 shows a first exemplary pattern forming element 350. The pattern forming element 350 and the other exemplary pattern forming elements discussed below are illustrated in cross section from the view of FIG. 1, as they would be encountered by the light beam 140. The pattern forming element 350 may be rectangular, as shown, or may be any other shape suited to produce a desired pattern. A light beam 140 may be incident on the pattern forming element 350 in a laser spot 360 elliptical cross section, as shown. The pattern forming element 350 may include a central refractive area 370 with no diffractive pattern. The refractive area 370 may simply be a hole in the pattern forming element 350, or it may be a clear optical window aperture, a lens, a flat plate, a filter, etc. The refractive area 370 allows a portion of the laser energy to propagate with little or no disturbance; this portion of the laser energy may typically be responsible for creating a bright central portion of an aiming pattern, such as the central dot 261 of the pattern 160 of FIG. 2.

Those skilled in the art will understand that, if the refractive area 370 is a hole or similar slit in the pattern forming element 350, there is no refractive index and the laser light may travel directly through the refractive area 370 to form the portion of the target pattern generated by the refractive area 370. In other exemplary embodiments, the refractive area 370 may be formed of a material having a defined refractive index. In such exemplary embodiments, the laser light will be refracted at an angle related to the refractive index of the material. Thus, the portion of the target that is generated by the refractive area 370 may be offset from the actual refractive area 370. In such an exemplary embodiment, the refractive area 370 may not be located in a central area of the pattern forming element, but may be located away from the center to account for the refractive index of the refractive area 370 and/or for the desired location of the portion of the target pattern generated by the refractive area 370.

The size of the refractive area 370 may be selected to allocate an appropriate amount of energy to the central dot 261. As an example, the incident laser spot 360 may provide 10 mW of power and 1 mW of power may be desired in central dot 261. If a uniform power distribution over the laser spot 360 is assumed, then the refractive area 370 would ideally be 1/10 the size of the laser spot 360. More realistically, the laser may typically have a Gaussian distribution of power. Because this is the case, those of skill in the art will understand that the power in the laser beam may be concentrated towards the center of the laser spot 360, and that the refractive area 370 may typically be sized smaller than 1/10 the size of the laser spot 360 for the above referenced power distribution.

The remainder of the pattern forming element 350 may comprise a diffractive optical element 380 for generating an aiming pattern, as discussed above. The portion of the laser spot 360 that is incident on the diffractive optical element 380 is diffracted, such as through constructive and destructive interference, to form the remainder of the aiming pattern, such as the lines 262, 263, 264, 265 of the pattern 160 shown in FIG. 2.

Those of skill in the art will understand that the length of the lines 262, 263, 264, 265 may be proportional to the diffraction angle produced by the diffractive optical element, linearly scaled by the distance to the target 170. The diffraction angle, in turn, may be proportional to the wavelength of the light provided by the light source 110 and inversely proportional to the feature size, or spatial resolution, of the diffractive optical element 350.

The exemplary system shown in FIG. 1 illustrates the use of a single pattern forming element 150. However, those of skill in the art will understand that other exemplary systems may have two or more pattern forming elements disposed longitudinally along the light beam; multiple such steps may typically be required to produce a more complicated aiming pattern. Additionally, the use of multiple steps may help to increase the efficiency and control of the aiming pattern. Such steps may typically be separated by half a wavelength, though other spacings are possible.

Though FIG. 3 illustrates a circular refractive area 370, those of skill in the art will understand that the shape of the refractive area 370 is only exemplary, and that other shapes are possible. For example, the refractive area may be elliptical or rectangular; alternately, the refractive area may be a circular or elliptical ring with a concentric pattern forming area. Additionally, the refractive aperture may be intentionally offset from the center of the laser spot. FIGS. 4-7 illustrate other exemplary pattern forming elements 150.

FIG. 4 shows an exemplary pattern forming element 450 with incident laser spot 460. The pattern forming element 450 comprises a rectangular refractive area 470 that is centered within the laser spot 460. The refractive area 470 is surrounded by a DOE 480.

FIG. 5 shows an exemplary pattern forming element 550 with incident laser spot 560. The pattern forming element 550 comprises a circular refractive area 570 that is centered within the laser spot 460. The refractive area 570 is surrounded by a DOE 580. Further, a second circular DOE 590 is located within the refractive area 570; the DOE 590 is also centered within the laser spot 560.

FIG. 6 shows an exemplary pattern forming element 650 with incident laser spot 660. The pattern forming element 650 comprises an elliptical refractive area 670 that is off-center within the laser spot 660. The refractive area 670 is surrounded by a DOE 680. Further, a second elliptical DOE 690 is located within the refractive area 670; the DOE 690 is off-center with respect to both the laser spot 660 and the refractive area 670.

FIG. 7 shows an exemplary pattern forming element 750 with incident laser spot 760. The pattern forming element 750 comprises a rectangular refractive area 770 that is off-center within the laser spot 760. The refractive area 770 is surrounded by a DOE 780.

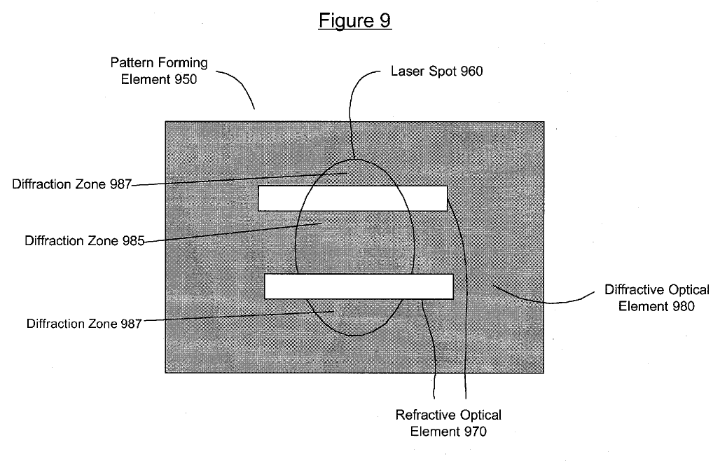

FIG. 8 shows an exemplary pattern forming element 850 with incident laser spot 860. The pattern forming element 850 comprises a circular refractive area 870 that is off-center within the laser spot 860. The refractive area 870 is surrounded by a DOE 880. Further, a second circular DOE 890 is located within the refractive area 870; the DOE 890 is off-center with respect to the laser spot 860 but centered within the refractive area 870.

FIG. 9 shows an exemplary pattern forming element 950 with incident laser spot 960. The pattern forming element 950 comprises a plurality (in this example 2) of rectangular refractive areas 970 that set at equal distances from the center of the laser spot 960. The refractive areas 970 are surrounded by a DOE 980. In this exemplary embodiment, the two refractive areas 970 may self compensate for alignment errors in a first direction (e.g., vertical direction), while the selected shape (i.e., a rectangle having two sides substantially longer than the other two sides) may reduce alignment errors in the other direction (e.g., horizontal direction).

Referring to the aiming pattern 160 of FIG. 2, the two refractive areas 970 may be used to create the central dot 261. It can be seen that a lateral shift of the laser spot 960 over the pattern forming element 950 practically does not change relative power of the central dot 261. If laser spot 960 is shifted horizontally, there is not change at all. If the laser spot 960 shifts vertically, laser spot power over one slit (refractive area) decreases and over another slit (refractive area) increases, so that the total power through the two slits (refractive areas 970) forming the central dot 261 does not change.

The horizontal lines 263 and 265 may be created by the zone 985 of the DOE 280 between the two refractive areas 970. The vertical lines 262 and 264 may be created by the zones 987 of the DOE 980 that lie outside the respective refractive areas 970. Accordingly, it may be seen how the exemplary pattern forming element 950 having multiple refractive areas 970 and multiple zones 985 and 987 of the DOE 980 may create an exemplary aiming pattern.

The quality (sharpness and cleanness) of the aiming pattern may be achieved by simplifying surface geometry because each zone forms less components of the aiming pattern. Further, the geometry of the zones is preferably chosen to minimize variation of laser power in different aiming pattern components. Thus, in the exemplary pattern forming element 950, each zone contributes to only one component of the aiming pattern, e.g., the refractive areas 970 in the form of two slit-shaped clear flat zones form the central aiming dot 261, the zone 985 of the DOE 980 forms the horizontal aiming lines 263 and 265, and the two outer zones 987 form the vertical aiming lines 262 and 264.

It should also be noted that, each of the zones may be implemented using diffraction or refraction technology. That is, it is possible to create the lines and/or the center dot of the aiming pattern using refractive area(s) and/or diffractive area(s).

Those of skill in the art will understand that the exemplary embodiments of the present invention improve the efficiency of light utilization by using a high numerical aperture collimating lens in conjunction with a pattern forming element with a central refractive area to allow passage of a large portion of incident light. Further, the exemplary embodiments may reduce secondary pattern dots and provide improved quality and sharpness among the aiming lines and dots that are created. In addition, those skilled in the art will understand that there are numerous other types of arrangements of refractive and diffractive elements that may be used based on the desired target pattern.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A device, comprising:
a diffractive optical element portion diffracting an incident light beam to create a first portion of a target pattern; and
a refractive optical element portion refracting the incident light beam to create a second portion of the target pattern.

2. The device of claim 1, wherein the refractive optical element portion is one of a hole, a window aperture, a lens, a slit, and a filter.

3. The device of claim 1, wherein the refractive optical element portion is completely surrounded by the diffractive optical element portion.

4. The device of claim 1, wherein the refractive optical element portion is one of circular, elliptical, and rectangular.

5. The device of claim 1, wherein the refractive optical element portion is one of centered with and off-center in relation to the incident light beam.

6. The device of claim 1, further comprising:
a second diffractive optical element portion that is completely surrounded by the refractive optical element portion.

7. The device of claim 6, wherein the second diffractive optical element portion is one of circular, elliptical, rectangular, diamond shaped and a slit.

8. The device of claim 1, wherein the target pattern comprises a central dot and a plurality of lines.

9. The device of claim 1, wherein the refractive optical element portion is sized to pass a size of the incident light beam corresponding to a predetermined amount of power.

10. The device of claim 1, further comprising:
a second refractive optical element portion refracting the incident light beam to create a third portion of the target pattern.

11. The device of claim 10, wherein the refractive optical element portion and the second refractive optical element portion are separated by the diffractive optical element portion.

12. The device of claim 1, wherein the diffractive optical element portion includes a plurality of diffraction zones, each diffraction zone corresponding to a feature of the target pattern.

13. A system, comprising:
a light source generating a light beam;
a collimating lens collimating the light beam into a collimated light beam; and
a pattern generating element comprising a diffractive optical element portion and a refractive optical element portion, the pattern generating element creating a target pattern from the collimated light beam incident on the pattern generating element.

14. The system of claim 13, wherein the light source is a laser diode.

15. The system of claim 13, wherein the collimating lens is a high numerical aperture laser collimating lens.

16. The system of claim 13, wherein the refractive optical element portion is one of circular, elliptical, rectangular, diamond shaped and a slit.

17. The system of claim 13, wherein the refractive optical element portion is one of centered with and off-center with the collimated light beam incident on the pattern generating element.

18. The system of claim 13, wherein the pattern generating element further comprises a second diffractive optical element portion disposed within the refractive optical element portion.

19. The system of claim 18, wherein the second diffractive optical element portion is one of circular, elliptical, and rectangular.

20. The system of claim 13, wherein the target pattern comprises a central dot and a plurality of lines.

21. The system of claim 13, wherein the refractive optical element portion is completely surrounded by the diffractive optical element portion.

22. The system of claim 13, wherein the refractive optical element portion is sized to pass a size of the incident light beam corresponding to a predetermined amount of power.

23. The system of claim 13, further comprising:
a further pattern generating element located in a same optical path as the pattern generating element, the further pattern generating element comprising a further diffractive optical element portion and a further refractive optical element portion, the further pattern generating element receiving the target pattern from the pattern generating element and creating a further target pattern.

24. A device, comprising:
means for diffracting an incident light beam to create a first portion of a target pattern; and
means for refracting the incident light beam to create a second portion of the target pattern.

25. A system comprising:
means for generating a light beam;
means for collimating the light beam into a collimated light beam; and
a pattern generating element comprising:
means for diffracting the collimated light beam to create a first portion of a target pattern, and
means for refracting the collimated light beam to create a second portion of the target pattern.
